(19) United States
(12) Patent Application Publication
(10) Pub. No.: US 2025/0251864 A1
(43) Pub. Date: Aug. 7, 2025

(54) NDEP LOW STRESS REFRESH ERASE

(71) Applicant: Micron Technology, Inc., Boise, ID (US)

(72) Inventors: Murong Lang, San Jose, CA (US); Lei Lin, Fremont, CA (US); Guang Hu, Mountain View, CA (US); Zhongguang Xu, San Jose, CA (US); Hanping Chen, San Jose, CA (US); Zhenming Zhou, San Jose, CA (US); Ronit Roneel Prakash, Minato City (JP)

(21) Appl. No.: 19/046,294

(22) Filed: Feb. 5, 2025

Related U.S. Application Data
(60) Provisional application No. 63/550,321, filed on Feb. 6, 2024.

(51) Int. Cl. G06F 3/06

(52) U.S. Cl. CPC G06F 3/0613; G06F 3/0659; G06F 3/0679

(57) ABSTRACT

Aspects of the present disclosure configure a memory sub-system controller to perform a low-stress refresh erase (LSRE) in response to NAND detect empty page (NDEP) operations. The controller performs a first type of erase operation on a portion of a set of memory components. The controller performs a set of memory operations for detecting an empty page in the portion of the set of memory components. The controller, in response to determining that the set of memory operations for detecting the empty page in the portion of the set of memory components has failed, performs a second type of erase operation on the portion of the set of memory components.

### PRIORITY APPLICATION

This application claims the benefit of priority to U.S. Provisional Application Ser. No. 63/550,321, filed Feb. 6, 2024, which is incorporated herein by reference in its entirety.

### TECHNICAL FIELD

Examples of the disclosure relate generally to memory sub-systems and, more specifically, to providing adaptive media management for memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some examples.

FIG. 2 is a block diagram of an example media operations manager, in accordance with some examples.

FIG. 3 is a block diagram of an example waveform for different types of memory erase operations, in accordance with some examples.

FIGS. 4 and 5 are flow diagrams example methods to perform a low-stress refresh erase (LSRE) in response to NAND detect empty page (NDEP) operations, in accordance with some examples.

FIG. 6 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

Aspects of the present disclosure configure a system component, such as a memory sub-system controller, to identify memory portions that fail NDEP operations after being erased and performing more efficient (and faster) erase operations for re-erasing the blocks. For example, instead of performing a conventional erase operation that erases blocks in two erase loops, the controller performs LSRE operations to re-erase the portions in one erase loop. This improves the overall efficiency of operating the memory sub-system.

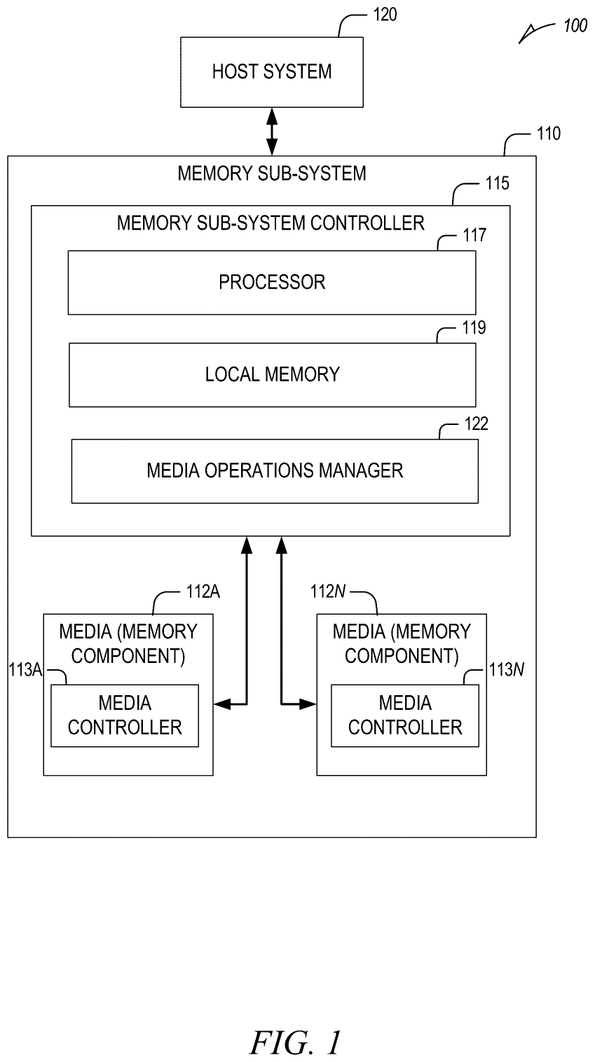

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data”.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data.” “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. The near-miss ECC refreshes all data read by the application that exceeds a configured threshold of errors. The dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which combine a raw memory device with a locally embedded controller for memory management within the same memory device package.

Typical memory systems perform NDEP operations (e.g., NDEP fold operations or NDEP scan operations) on memory pages/blocks which contain undesired charge gain. Such NDEP operations refresh or rewrite the memory pages/blocks to address the undesired charge gain. The NDEP operations are usually performed on blocks that have been erased and are waiting to be programmed, such as in response to receiving a request to program data into the blocks. Such blocks can be single-level cell (SLC) blocks and/or tri-level cell (TLC) blocks. If the NDEP operations fail, the convention memory systems re-erase these blocks before programming the data in the blocks. The need to re-erase the blocks prior to programming takes time and reduces the overall efficiency of the memory system. Some memory systems perform the initial erase of the blocks to improve write boost (WB) performance. Some of the WB pool blocks (e.g., SLC) are converted to non-WB blocks (e.g., TLC) when storage space fills up. However, if the blocks are previously SLC pre-erased and need to be programmed to TLC later, then the SLC pre-erased blocks need to be TLC erased again. This is because the SLC erase is shallower than TLC erase. This SLC+TLC double erase induces extra erase stress which degrades wear ratio and total bytes written (TBW).

Another possible scenario is that if one block (SLC/TLC) stays in erase for a long time before being programmed, the E0 might degrade due to charge gain. This could trigger a double erase again due to the NDEP scan failure. Again, double erase is not preferred due to the adverse impact on the wear ratio.

Aspects of the present disclosure address the above and other deficiencies by providing a memory controller that can apply a higher efficiency erase operation in cases where the NDEP scan operations fail for previously erased memory portions. This way, instead of re-erasing the memory portions with the same erase operation type that is usually performed in two erase loops, the memory controller can apply an erase operation that is performed in a single erase loop. This increases the overall efficiency of the memory system and reduces the amount of time it takes to prepare memory blocks for programming.

In some examples, the memory controller performs a first type of erase operation on a portion of the set of memory components. The memory controller performs a set of memory operations for detecting an empty page in the portion of the set of memory components. The memory controller, in response to determining that the set of memory operations for detecting the empty page in the portion of the set of memory components has failed, performs a second type of erase operation on the portion of the set of memory components.

In some cases, the memory controller receives a request to program data to the set of memory components. The memory controller then programs the data to the portion of the set of memory components that has been erased with the second type of erase operation. In some cases, the memory controller, in response to determining that the set of memory operations for detecting the empty page in the portion of the set of memory components has passed, programs data to the portion of the set of memory components that has been erased with the first type of erase operation.

The first type of erase operation can include applying a pre-program pulse prior to applying a first threshold voltage to erase the portion of the set of memory components. The second type of erase operation can include applying a second threshold voltage to erase the portion of the set of memory components without first applying the pre-program pulse. The second threshold voltage can be lower than the first threshold voltage. The first type of erase operation completes in two erase loops and the second type of erase operation completes in one erase loop.

In some examples, the set of memory operations includes a NAND detect empty page (NDEP) operation. The NDEP operation reads a block of data to detect charge gain and refreshes the block of data.

The memory controller accesses a set of blocks in a garbage collection pool. The memory controller selects a first block in the set of blocks as the portion of the set of memory components and performs the first type of erase operation on the first block. In some cases, the memory controller receives a request to program data in the first block in the set of blocks that has been erased with the first type of erase operation and, in response to receiving the request to program the first block, performs the set of memory operations for detecting the empty page in the first block.

The request to program the data includes a request to perform at least one of a single-level cell (SLC) block program operation or a tri-level cell (TLC) block program operation. In some examples, the portion of the set of memory components includes at least one of a single-level cell (SLC) block or a tri-level cell (TLC) block.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples of the present disclosure. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies).

In some examples, the first memory component 112A, block or page of the first memory component 112A, or group of memory components including the first memory component 112A can be associated with a first reliability (capability) grade, value, or measure. The terms “reliability grade,” “value” and “measure” are used interchangeably throughout and can have the same meaning. The second memory component 112N or group of memory components including the second memory component 112N can be associated with a second reliability (capability) grade, value, or measure. In some examples, each memory component 112A to 112N can store respective configuration data that specifies the respective reliability grade. In some examples, a memory or register can be associated with all of the memory components 112A to 112N, which can store a table that maps different groups, bins, or sets of the memory components 112A to 112N to respective reliability grades. In some cases, the table can specify bins each representing a respective plurality of portions of the memory components 112A to 112N that is associated with a certain likelihood of having extrinsic bitline defects. Namely, during manufacture, bins can be defined that group different memory components 112A to 112N (e.g., based on memory addresses). Each bin can be associated with a respective likelihood that the corresponding memory components 112A to 112N are likely to have or experience extrinsic bitline defects. These bins can be stored in configuration data associated with the memory sub-system 110.

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes a negative-and (NAND)-type flash memory. Each of the memory components 112A to 112N can include one or more arrays of memory cells such as single-level cells (SLCs) or multi-level cells (MLCs) (e.g., TLCs or QLCs). In some examples, data can be programmed to a SLC memory component and later migrated to a TLC memory component.

In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some embodiments, the memory components 112A to 112N can be, but are not limited to, random access memory (RAM), read-only memory (ROM), dynamic random access memory (DRAM), synchronous dynamic random access memory (SDRAM), phase change memory (PCM), magneto resistive random access memory (MRAM), negative-or (NOR) flash memory, electrically erasable programmable read-only memory (EEPROM), and a cross-point array of non-volatile memory cells. A cross-point array of non-volatile memory cells can perform bit storage based on a change of bulk resistance, in conjunction with a stackable cross-gridded data access array.

Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. For example, a single first row that spans memory components 112A to 112N can correspond to or be grouped as a first superblock and a single second row that spans memory components 112A to 112N can correspond to or be grouped as a second superblock. If the single first row includes all good blocks (e.g., each block in the single first row has a reliability grade above a threshold), the first superblock is a first complete superblock. If the single first row includes some bad blocks (e.g., one or more blocks in the single first row have a reliability grade below a threshold), the first superblock is a first incomplete superblock.

The memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations, such as different scan rates, different scan frequencies, different wear leveling, different read disturb management, different NDEP operations to read a block of data to detect charge gain and refresh the block of data, different near miss ECC operations, and/or different dynamic data refreshes.

The memory sub-system controller 115 can include hardware such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another embodiment of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112N to 112N. The configuration data can describe the reliability grades and/or indications of defects in certain WGRs associated with different groups of the memory components 112N to 112N and/or different blocks within each of the memory components 112N to 112N and/or different bins and respective memory components 112N to 112N that are likely to experience extrinsic bitline defects. In some cases, the reliability grades are dynamic and can be updated by the memory sub-system controller 115 in response to determining that certain error rates are reached that transgress an error rate threshold.

The memory sub-system controller 115 can be responsible for other memory management operations, such as wear leveling operations, garbage collection operations, error detection and error-correcting code (ECC) operations, encryption operations, caching operations, NDEP operations (e.g., NDEP scan operations), and address translations. The memory sub-system controller 115 can further include host interface circuitry to communicate with the host system 120 via the physical host interface. The host interface circuitry can convert the commands received from the host system 120 into command instructions to access the memory components 112A to 112N as well as to convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which are raw memory devices combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can include a media operations manager 122. The media operations manager 122 performs a low-stress refresh erase (LSRE) in response to NAND detect empty page (NDEP) operations. For example, the media operations manager 122 can place a set of memory components in a GC pool to prepare the set of memory components for programming with data. The media operations manager 122 can select one or more memory components to erase according to a first type of erase operation. After erasing the one or more memory components, the media operations manager 122 can test the one or more memory components for detecting an empty page, such as using NDEP scan operations. If the one or more memory components fail the test of the NDEP scan operations, the media operations manager 122 performs a second type of erase operation on the portion of the set of memory components which have been erased according to the first type of erase operation and prior to programming data into the one or more memory components.

Depending on the example, the media operations manager 122 can comprise logic (e.g., a set of transitory or non-transitory machine instructions, such as firmware) or one or more components that cause the media operations manager 122 to perform operations described herein. The media operations manager 122 can comprise a tangible or non-tangible unit capable of performing the operations described herein. Further details about the operations of the media operations manager 122 are described below.

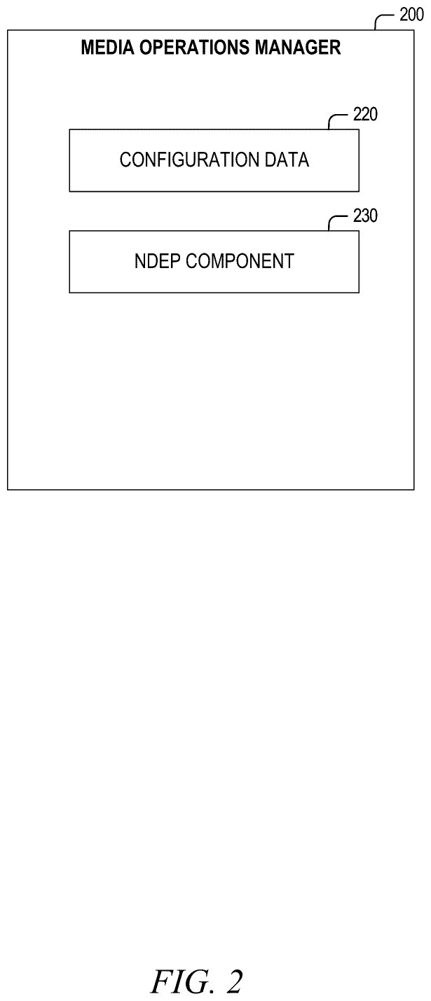

FIG. 2 is a block diagram of an example media operations manager 200, in accordance with some examples. The media operations manager 200 can include some or all of the components of the media operations manager 122, shown in FIG. 1. As illustrated, the media operations manager 122 includes configuration data 220 and an NDEP component 230. For some examples, the media operations manager 200 can differ in components or arrangement (e.g., less or more components) from what is illustrated in FIG. 2.

The configuration data 220 accesses and/or stores configuration data associated with the memory components 112A to 112N. In some examples, the configuration data 220 is programmed into the media operations manager 122 during manufacture of the memory sub-system 110. The media operations manager 122 can communicate with the memory components 112A to 112N to obtain the configuration data and store the configuration data 220 locally on the media operations manager 122. In some examples, the media operations manager 122 communicates with the host system 120. The host system 120 receives input from an operator or user that specifies parameters including indications of defects (e.g., that can lead or be associated with extrinsic bitline defects) present on different WGRs, different bins, groups, blocks, or sets of the memory components 112A to 112N. The media operations manager 122 receives configuration data from the host system 120 and stores the configuration data in the configuration data 220.

In some examples, the NDEP component 230 performs NDEP scan operations to detect an empty page in a portion of the set of memory components 112A to 112N. For example, the NDEP component 230 can access one or more memory components of the set of memory components 112A to 112N that are in a GC pool. These are memory components that contain invalid data and need to be erased before being reprogrammed.

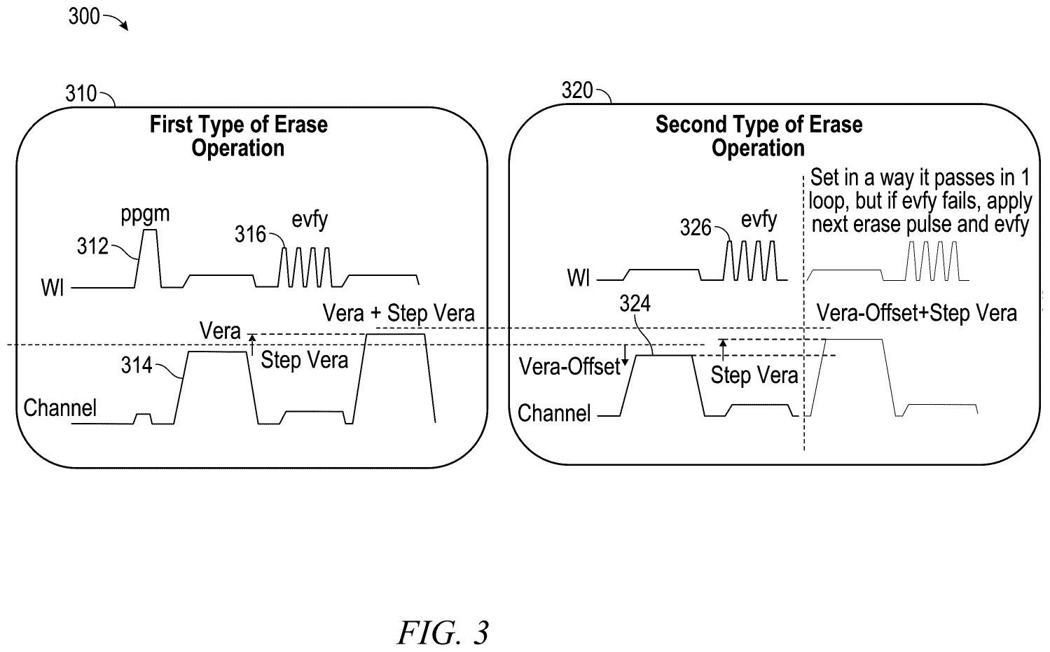

The NDEP component 230 can select an individual set or group of the one or more memory components that are in the GC pool. The NDEP component 230 can then apply a first type of erase operation on the selected individual set or group of the one or more memory components. For example, as shown in the diagram 300 of FIG. 3, the NDEP component 230 can apply a first type of erase operation 310. The first type of erase operation 310 includes the application of a pre-program voltage 312 to one or more word lines. Then the NDEP component 230 applies a first threshold voltage 314 (this is a first erase voltage value) to a channel in order to erase the data stored to the selected set or group of the one or more memory components. After the first threshold voltage 314 is applied to the channel, the NDEP component 230 performs a set of erase verify operations 316 to test the status of erasure of the selected set or group of the one or more memory components. As a final operation, the NDEP component 230 applies an additional threshold voltage (that is greater than the first threshold voltage 314) to the selected set or group of the one or more memory components after performing the erase verify operations 316. This completes the operations for erasing the set or group of the one or more memory components according to the first type of erase operation 310.

After the set or group of the one or more memory components have been erased according to the first type of erase operation 310, the NDEP component 230 places the selected set or group of the one or more memory components in a ready to program state. The NDEP component 230 waits for receiving a program command. For example, the NDEP component 230 can receive the program command to program data from the host system 120. As another example, the NDEP component 230 can receive the program command from the memory sub-system controller 115 to move data that has been stored to an SLC memory component to TLC storage.

In response to receiving the request to program data to the selected set or group of the one or more memory components, the NDEP component 230 performs an NDEP scan operation to test whether an empty page is detected in the selected set or group of the one or more memory components. The NDEP component 230 selectively programs the data to the selected set or group of the one or more memory components based on the outcome of the NDEP scan operation. For example, if the selected set or group of the one or more memory components passes the NDEP scan operation, the NDEP component 230 programs the data to the selected set or group of the one or more memory components that has been erased according to the first type of erase operation 310.

In some cases, the NDEP component 230 determines that the selected set or group of the one or more memory components fails the NDEP scan operation. In such cases, the NDEP component 230 may need to re-erase the selected set or group of the one or more memory components that have been previously erased using the first type of erase operation 310. In order to re-erase the selected set or group of the one or more memory components more efficiently, the NDEP component 230 performs a second type of erase operation 320 to re-erase the selected set or group of the one or more memory components instead of the first type of erase operation 310. The second type of erase operation 320 can correspond to an LSRE operation.

Specifically, the second type of erase operation 320 includes application of a second threshold voltage 324 (this is a second erase voltage value) to a channel in order to re-erase the data stored to the selected set or group of the one or more memory components. The second threshold voltage 324 can be of a lower value than the first threshold voltage 314 by a specified amount stored in the configuration data. After the second threshold voltage 324 is applied to the channel, the NDEP component 230 performs a set of erase verify operations 326 to test the status of erasure of the selected set or group of the one or more memory components. This completes the operations for re-erasing the set or group of the one or more memory components according to the second type of erase operation 320. In this way, the second type of erase operation 320 erases data programmed to the selected set or group of the one or more memory components without first applying the pre-program voltage 312 and in a single loop (e.g., without having to apply the erase voltage twice to the channel, as in the first type of erase operation 310). In some cases, if the Erase Verify Operations 326 fail, then, the NDEP component 230, as a final operation, applies an additional threshold voltage (e.g., a voltage that is greater than the second threshold voltage 324) to the selected set or group of the one or more memory components. After re-erasing the selected set or group of the one or more memory components, the NDEP component 230 programs the data to the selected set or group of the one or more memory components that has been erased according to the second type of erase operation 320.

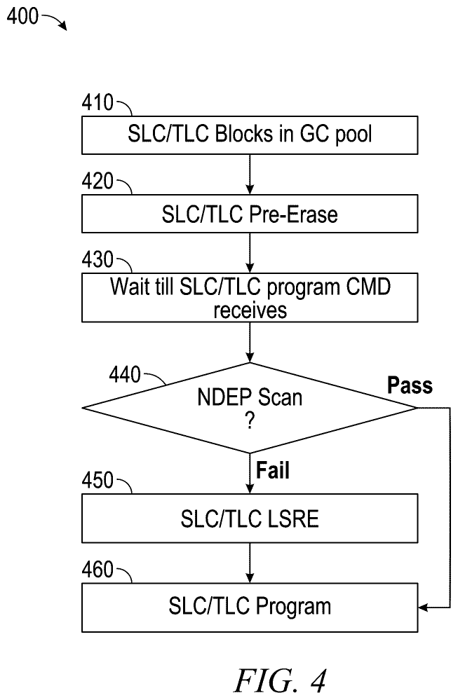

FIG. 4 is a flow diagram of an example process or method 400 to perform a low-stress refresh erase (LSRE) in response to NAND detect empty page (NDEP) operations, in accordance with some examples. The process or method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the process or method 400 is performed by the media operations manager 122 of FIG. 1. Although the process and method are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible. The process or method 400 can be performed in the alternative or in combination with each other.

Referring now to FIG. 4, the process or method 400 begins at operation 410, with a media operations manager 122 of a memory sub-system (e.g., memory sub-system 110 of FIG. 1) storing a set of SLC and/or TLC blocks in a garbage collection (GC) pool. Then, at operation 420, the media operations manager 122 selects a portion of the set of SLC and/or TLC blocks to erase according to a first type of erase operation. The first type of erase operation can apply a pre-program voltage followed by a first threshold voltage to erase the selected portion of the set of SLC and/or TLC blocks.

The media operations manager 122 waits, at operation 430, to receive a command to program data into the set of SLC and/or TLC blocks that have been erased according to the first type of erase operation. In response to receiving a command to program data into the set of SLC and/or TLC blocks (e.g., from the memory sub-system controller 115 and/or the host system 120), the media operations manager 122 performs operation 440. At operation 440, the media operations manager 122 performs an NDEP scan (e.g., a set of memory operations) to test the reliability of the set of SLC and/or TLC blocks (e.g., for detecting an empty page in the portion of the set of memory components). In response to determining that the set of SLC and/or TLC blocks pass the NDEP scan, the media operations manager 122 performs operation 460. In response to determining that the set of SLC and/or TLC blocks fail the NDEP scan, the media operations manager 122 performs operation 450. For example, at operation 460, the media operations manager 122 programs the set of SLC and/or TLC blocks, which have been erased according to the first type of erase operation with the requested data.

For example, at operation 450, the media operations manager 122 performs a second type of erase operation on the set of SLC and/or TLC blocks. The second type of erase operation can include an LSRE erase operation. The LSRE erase operation includes application of a second threshold voltage (lower than the first threshold voltage of the first type of erase operation) without first applying the pre-program voltage. This allows the second type of erase operation to complete faster than the first type of erase operation and more efficiently. After completing operation 450, the media operations manager 122 performs operation 460 to program the set of SLC and/or TLC blocks, which have been erased according to the second type of erase operation with the requested data.

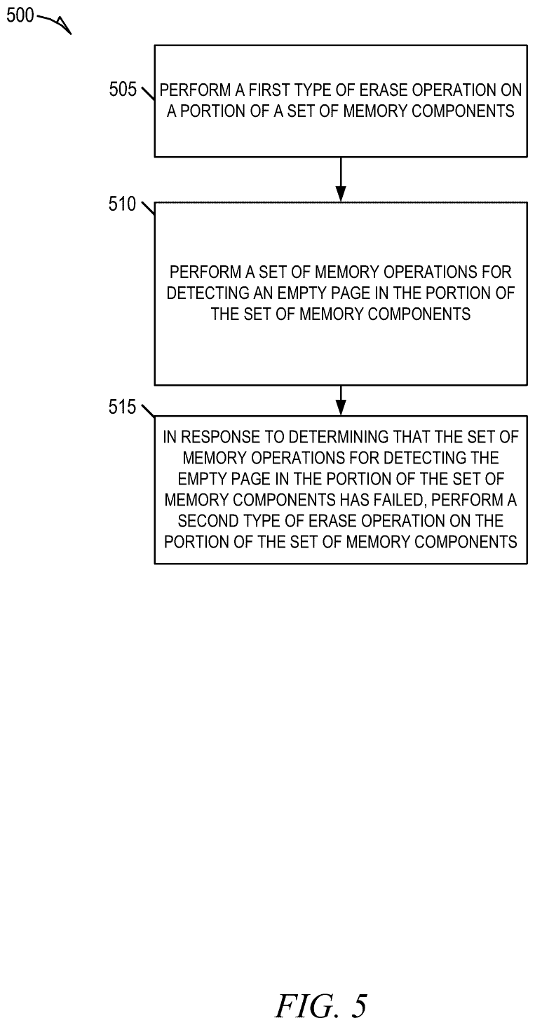

FIG. 5 is a flow diagram of an example process or method 500 to perform a low-stress refresh erase (LSRE) in response to NAND detect empty page (NDEP) operations, in accordance with some examples. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the media operations manager 122 of FIG. 1. Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 5, the method 500 begins at operation 505, with a media operations manager 122 of a memory sub-system (e.g., memory sub-system 110) performing a first type of erase operation on a portion of the set of memory components. Then, the media operations manager 122 performs a set of memory operations (e.g., NDEP operations), at operation 510, for performing a set of memory operations for detecting an empty page in the portion of the set of memory components. Next, at operation 515, the media operations manager 122 in response to determining that the set of memory operations for detecting the empty page in the portion of the set of memory components has failed, performs a second type of erase operation on the portion of the set of memory components.

In view of the disclosure above, various examples are set forth below. It should be noted that one or more features of an example, taken in isolation or combination, should be considered within the disclosure of this application.

Example 1. A system comprising: a set of memory components of a memory sub-system; and at least one processing device operatively coupled to the set of memory components, the at least one processing device configured to perform operations comprising: performing a first type of erase operation on a portion of the set of memory components; performing a set of memory operations for detecting an empty page in the portion of the set of memory components; and in response to determining that the set of memory operations for detecting the empty page in the portion of the set of memory components has failed, performing a second type of erase operation on the portion of the set of memory components.

Example 2. The system of Example 1, the operations comprising: receiving a request to program data to the set of memory components; and programming the data to the portion of the set of memory components that has been erased with the second type of erase operation.

Example 3. The system of any one of Examples 1-2, the operations comprising: in response to determining that the set of memory operations for detecting the empty page in the portion of the set of memory components has passed, programming data to the portion of the set of memory components that has been erased with the first type of erase operation.

Example 4. The system of any one of Examples 1-3, wherein the first type of erase operation comprises applying a pre-program pulse prior to applying a first threshold voltage to erase the portion of the set of memory components.

Example 5. The system of Example 4, wherein the second type of erase operation comprises applying a second threshold voltage to erase the portion of the set of memory components without first applying the pre-program pulse.

Example 6. The system of Example 5, wherein the second threshold voltage is lower than the first threshold voltage.

Example 7. The system of any one of Examples 1-6, wherein the first type of erase operation completes in two erase loops and the second type of erase operation completes in one erase loop.

Example 8. The system of any one of Examples 1-7, wherein the set of memory operations includes a NAND detect empty page (NDEP) operation.

Example 9. The system of Example 8, wherein the NDEP operation reads a block of data to detect charge gain and refreshes the block of data.

Example 10. The system of any one of Examples 1-9, the operations comprising: accessing a set of blocks in a garbage collection pool; selecting a first block in the set of blocks as the portion of the set of memory components; and performing the first type of erase operation on the first block.

Example 11. The system of Example 10, the operations comprising: receiving a request to program data in the first block in the set of blocks that has been erased with the first type of erase operation; and in response to receiving the request to program the first block, performing the set of memory operations for detecting the empty page in the first block.

Example 12. The system of Example 11, wherein the request to program the data comprises a request to perform at least one of a single-level cell (SLC) block program operation or a tri-level cell (TLC) block program operation.

Example 13. The system of any one of Examples 1-12, wherein the portion of the set of memory components comprises at least one of a single-level cell (SLC) block or a tri-level cell (TLC) block.

Methods and computer-readable storage medium with instructions for performing any one of the above examples.

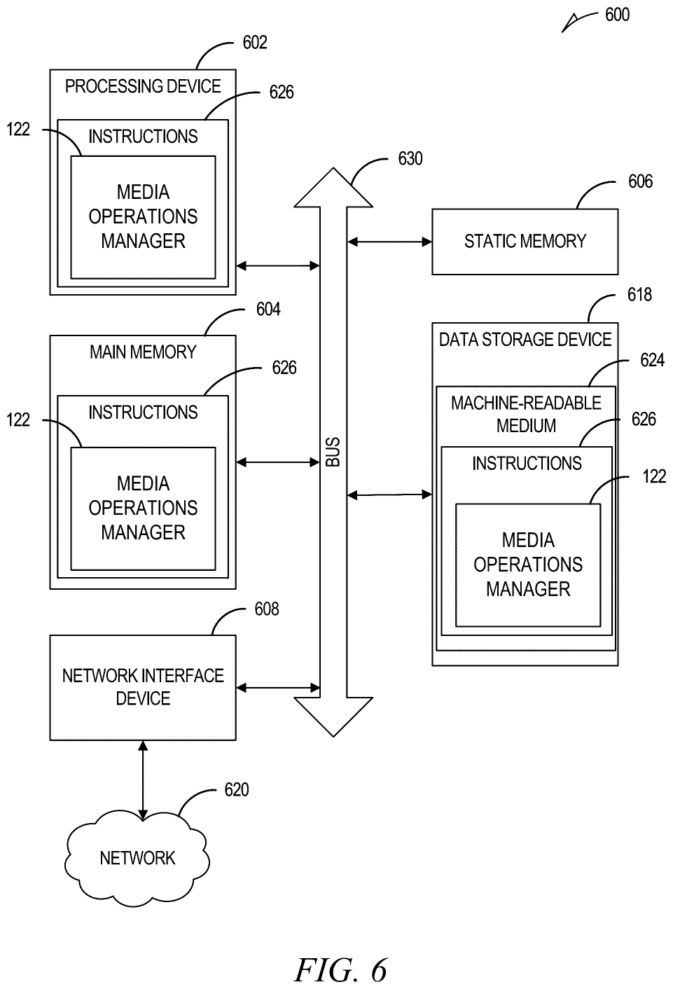

FIG. 6 illustrates an example machine in the form of a computer system 600 within which a set of instructions can be executed for causing the machine to perform any one or more of the methodologies discussed herein. In some examples, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 implement functionality corresponding to the media operations manager 122 of FIG. 1. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a set of memory components of a memory sub-system; and
at least one processing device operatively coupled to the set of memory components, the at least one processing device configured to perform operations comprising:
performing a first type of erase operation on a portion of the set of memory components;
performing a set of memory operations for detecting an empty page in the portion of the set of memory components; and
in response to determining that the set of memory operations for detecting the empty page in the portion of the set of memory components has failed, performing a second type of erase operation on the portion of the set of memory components.

2. The system of claim 1, the operations comprising:
receiving a request to program data to the set of memory components; and
programming the data to the portion of the set of memory components that has been erased with the second type of erase operation.

3. The system of claim 1, the operations comprising:
in response to determining that the set of memory operations for detecting the empty page in the portion of the set of memory components has passed, programming data to the portion of the set of memory components that has been erased with the first type of erase operation.

4. The system of claim 1, wherein the first type of erase operation comprises applying a pre-program pulse prior to applying a first threshold voltage to erase the portion of the set of memory components.

5. The system of claim 4, wherein the second type of erase operation comprises applying a second threshold voltage to erase the portion of the set of memory components without first applying the pre-program pulse.

6. The system of claim 5, wherein the second threshold voltage is lower than the first threshold voltage.

7. The system of claim 1, wherein the first type of erase operation completes in two erase loops and the second type of erase operation completes in one erase loop.

8. The system of claim 1, wherein the set of memory operations includes a NAND detect empty page (NDEP) operation.

9. The system of claim 8, wherein the NDEP operation reads a block of data to detect charge gain and refreshes the block of data.

10. The system of claim 1, the operations comprising:
accessing a set of blocks in a garbage collection pool;
selecting a first block in the set of blocks as the portion of the set of memory components; and
performing the first type of erase operation on the first block.

11. The system of claim 10, the operations comprising:
receiving a request to program data in the first block in the set of blocks that has been erased with the first type of erase operation; and
in response to receiving the request to program the first block, performing the set of memory operations for detecting the empty page in the first block.

12. The system of claim 11, wherein the request to program the data comprises a request to perform at least one of a single-level cell (SLC) block program operation or a tri-level cell (TLC) block program operation.

13. The system of claim 1, wherein the portion of the set of memory components comprises at least one of a single-level cell (SLC) block or a tri-level cell (TLC) block.

14. A method comprising:
performing a first type of erase operation on a portion of a set of memory components;
performing a set of memory operations for detecting an empty page in the portion of the set of memory components; and
in response to determining that the set of memory operations for detecting the empty page in the portion of the set of memory components has failed, performing a second type of erase operation on the portion of the set of memory components.

15. The method of claim 14, comprising:
receiving a request to program data to the set of memory components; and
programming the data to the portion of the set of memory components that has been erased with the second type of erase operation.

16. The method of claim 14, comprising:
in response to determining that the set of memory operations for detecting the empty page in the portion of the set of memory components has passed, programming data to the portion of the set of memory components that has been erased with the first type of erase operation.

17. The method of claim 14, wherein the first type of erase operation comprises applying a pre-program pulse prior to applying a first threshold voltage to erase the portion of the set of memory components.

18. The method of claim 17, wherein the second type of erase operation comprises applying a second threshold voltage to erase the portion of the set of memory components without first applying the pre-program pulse.

19. The method of claim 18, wherein the second threshold voltage is lower than the first threshold voltage.

20. A non-transitory computer-readable storage medium comprising instructions that, when executed by at least one processing device, cause the at least one processing device to perform operations comprising:
performing a first type of erase operation on a portion of a set of memory components;
performing a set of memory operations for detecting an empty page in the portion of the set of memory components; and
in response to determining that the set of memory operations for detecting the empty page in the portion of the set of memory components has failed, performing a second type of erase operation on the portion of the set of memory components.
